(19) United States
(12) Patent Application Publication
(10) Pub. No.: US 2024/0371575 A1
(43) Pub. Date: Nov. 7, 2024

(54) ELECTRODE FOIL FOR ELECTROLYTIC CAPACITORS, AND ELECTROLYTIC CAPACITOR

(71) Applicant: Panasonic Intellectual Property Management Co., Ltd., Osaka (JP)

(72) Inventors: Mitsuhisa YOSHIMURA, OSAKA FU (JP); Toshifumi KADOKAWA, HYOGO KEN (JP); Masami TSUBAKI, KYOTO FU (JP); Yuji OTSUKA, KYOTO FU (JP)

(21) Appl. No.: 18/292,788

(22) PCT Filed: Jul. 25, 2022
(86) PCT No.: PCT/JP2022/028586

§ 371 Date: Jan. 26, 2024

(30) Foreign Application Priority Data
Jul. 30, 2021 (JP) 2021-126283

(51) Int. Cl. H01G 9/055

(52) U.S. Cl. CPC H01G 9/055

(57) ABSTRACT

An electrode foil for an electrolytic capacitor includes a metal foil that includes a porous portion and a core portion continuous to the porous portion. The metal foil has a main surface in which pores in the porous portion are open. The porous portion includes a plurality of recessed portions that are open in the main surface and distributed in a dot pattern in an in-plane direction of the metal foil. The pores in the porous portion have an opening diameter smaller than 2 μm, recessed portions that are adjacent to each other have an opening diameter D₁ μm and an opening diameter D₂ μm, respectively, and are spaced apart from each other by a distance L μm, and the opening diameter D₁ and the distance L satisfy 2≤D₁ and 2≤L/D₁≤50. The opening diameter D₂ and the distance L satisfy 2≤D₂ and 2≤L/D₂≤50.

### CROSS-REFERENCE OF RELATED APPLICATIONS

This application is the U.S. National Phase under 35 U.S.C. § 371 of International Patent Application No. PCT/JP2022/028586, filed on Jul. 25, 2022, which in turn claims the benefit of Japanese Patent Application No. 2021-126283, filed on Jul. 30, 2021, the entire disclosures of which Applications are incorporated by reference herein.

### TECHNICAL FIELD

The present disclosure relates to an electrode foil for an electrolytic capacitor and an electrolytic capacitor.

### BACKGROUND ART

A metal foil that includes a porous portion and a core portion continuous to the porous portion is used for an electrode foil included in an electrolytic capacitor. The porous portion is formed by etching the metal foil. The surface area of the electrode foil is increased by forming the porous portion, and the capacitance of the electrolytic capacitor is consequently increased.

PTL 1 proposes a band-shaped electrode foil including: a surface enlarged part formed at a surface of the foil; a core part, which is the remaining part of the electrode foil excluding the surface enlarged part; and a plurality of separation parts extending in the width direction of the band-shaped electrode foil in the surface enlarged part and dividing the surface enlarged part. The separation parts have a groove width within a range of 50 μm or less, including 0, in a state where the foil is flat.

### CITATION LIST

### Patent Literature

PTL 1: Japanese Laid-Open Patent Publication No. 2017-224844

### SUMMARY OF INVENTION

### Technical Problem

When the separation parts are provided, a pushing depth (Erichsen value) in an Erichsen test increases. However, the separation parts extend in the width direction of the electrode foil, and folding endurance of the electrode foil in the width direction is low. Cracks are formed along the separation parts in the width direction of the electrode foil due to stress generated when the electrode foil is wound, leading to the generation of cracks extending almost straight from an end portion to another end portion of the electrode foil in the width direction. As a result, the electrode foil breaks. Breakage of an electrode foil when it is wound has not been sufficiently suppressed.

### Solution to Problem

An aspect of the present disclosure relates to an electrode foil for an electrolytic capacitor, including a metal foil that includes a porous portion and a core portion that is continuous to the porous portion, wherein the metal foil has a main surface in which pores in the porous portion are open, the porous portion includes a plurality of recessed portions that are open in the main surface and distributed in a dot pattern in an in-plane direction of the metal foil, the pores in the porous portion have an opening diameter smaller than 2 μm, recessed portions that are adjacent to each other among the recessed portions have an opening diameter D₁ μm and an opening diameter D₂ μm, respectively, and are spaced apart from each other by a distance L μm, the opening diameter D₁ and the distance L satisfy 2≤D₁ and 2≤L/D₁≤50, and the opening diameter D₂ and the distance L satisfy 2≤D₂ and 2≤L/D₂≤50.

Another aspect of the present disclosure relates to an electrolytic capacitor including a wound body and an electrolyte, wherein the wound body is obtained by winding together an anode foil, a cathode foil arranged opposite to the anode foil, and a separator arranged between the anode foil and the cathode foil, at least one of the anode foil and the cathode foil includes a metal foil that includes at least one porous portion and a core portion that is continuous to the porous portion, the metal foil has at least one main surface in which pores in the porous portion are open, the porous portion includes a plurality of recessed portions that are open in the main surface and distributed in a dot pattern in an in-plane direction of the main surface, the pores in the porous portion have an opening diameter smaller than 2 μm, recessed portions that are adjacent to each other among the recessed portions have an opening diameter D₁ μm and an opening diameter D₂ μm, respectively, and are spaced apart from each other by a distance L μm, the opening diameter D₁ and the distance L satisfy 2≤D₁ and 2≤L/D₁≤50, and the opening diameter D₂ and the distance L satisfy 2≤D₂ and 2≤L/D₂≤50.

Another aspect of the present disclosure relates to an electrolytic capacitor including a wound body and an electrolyte, wherein the wound body is obtained by winding together an anode foil, a cathode foil arranged opposite to the anode foil, and a separator arranged between the anode foil and the cathode foil, at least one of the anode foil and the cathode foil includes a metal foil that includes at least one porous portion and a core portion that is continuous to the porous portion, the metal foil has at least one main surface in which pores in the porous portion are open, the pores in the porous portion have an opening diameter smaller than 2 μm, the porous portion includes a plurality of recessed portions that are open in the main surface and distributed in a dot pattern in an in-plane direction of the main surface, the recessed portions have an opening diameter of 2 μm or more, and there are cracks between the recessed portions adjacent to each other.

### Advantageous Effects of Invention

According to the present disclosure, it is possible to suppress breakage of an electrode foil for an electrolytic capacitor when the electrode foil is wound.

Although novel features of the present invention are described in the attached claims, the following detailed description referring to the drawings together with other objects and features of the present invention will further facilitate understanding of both the configuration and the content of the present invention.

### BRIEF DESCRIPTION OF DRAWINGS

FIG. 1 is a front view schematically showing a main part of an example of an electrode foil for an electrolytic capacitor according to an embodiment of the present disclosure.

FIG. 2 is a front view schematically showing a main part of another example of an electrode foil for an electrolytic capacitor according to an embodiment of the present disclosure.

FIG. 3 is a cross-sectional view taken along the line III-III shown in FIG. 2.

FIG. 4 is an SEM image showing an electrode foil for an electrolytic capacitor according to an embodiment of the present disclosure after the electrode foil was wound.

FIG. 5 is a diagram schematically showing an example of a wound body as viewed from an end surface side.

FIG. 6 is a cross-sectional view schematically showing an electrolytic capacitor according to an embodiment of the present disclosure.

FIG. 7 is a perspective view schematically showing the configuration of a wound body shown in FIG. 6.

### DESCRIPTION OF EMBODIMENTS

The following describes examples of embodiments of an electrolytic capacitor according to the present disclosure, but the present disclosure is not limited to the following examples. In the following description, specific numerical values and materials are described as examples, but it is possible to apply other numerical values and materials as long as effects of the present disclosure can be obtained. In the present specification, the wording “from a numerical value A to a numerical value B” refers to a range that includes the numerical values A and B, and can be read as “the numerical value A or more and the numerical value B or less”. When examples of a lower limit value and examples of an upper limit value are described below regarding a specific physical property or condition, any of the examples of the lower limit value and the examples of the upper limit value can be combined unless the lower limit value is larger than or equal to the upper limit value. When a plurality of materials are described as examples, it is possible to use a single material selected therefrom or a combination of two or more materials selected therefrom.

Also, the present disclosure encompasses combinations of matters respectively recited in two or more claims selected from the attached claims. That is, it is possible to combine matters respectively recited in two or more claims selected from the attached claims, as long as no technical contradiction arises.

In the following description, the term “containing” or “including” encompasses “containing (or including)”, “consisting essentially of”, and “consisting of”.

The term “electrolytic capacitor” may be read as “solid electrolytic capacitor”. The term “capacitor” may be read as “condenser”.

### Electrode Foil for Electrolytic Capacitor

An electrode foil for an electrolytic capacitor according to an embodiment of the present disclosure includes a metal foil that includes a porous portion and a core portion that is continuous to the porous portion. The metal foil has a main surface (hereinafter also referred to as a “main surface S”) in which pores in the porous portion are open. The porous portion includes a plurality of recessed portions that are open in the main surface S. The plurality of recessed portions are distributed in a dot pattern in an in-plane direction of the metal foil (as viewed from the main surface S side). The recessed portions have a larger opening diameter than the pores in the porous portion. That is, the pores in the porous portion are smaller than 2 μm, and the opening diameter of the recessed portions is 2 μm or more. In the present specification, “the maximum diameter of an opening” is simply referred to as the “opening diameter”. That is, the “opening diameter of a recessed portion” refers to the maximum diameter of the opening of the recessed portion. The “opening diameter of a pore in the porous portion” refers to the maximum diameter of the opening of the pore. In the following description, the plurality of recessed portions distributed in a dot pattern in the in-plane direction of the metal foil and having an opening diameter of 2 μm or more will also be referred to as a “group of recessed portions”. The plurality of recessed portions are spaced apart from each other in the porous portion.

Recessed portions that are adjacent to each other have opening diameters of D₁ (μm) and D₂ (μm), respectively, and are spaced apart from each other by a distance L (μm). The opening diameter D₁ and the distance L satisfy 2≤D₁ and 2≤L/D₁≤50. The opening diameter D₂ and the distance L satisfy 2≤D₂ and 2≤L/D₂≤50.

D₁ and D₂ may be the same as each other or different from each other. Here, “D₁ and D₂ are the same as each other” means that D₁/D₂ falls within a range of 6/10 or more and 10/6 or less. D₁/D₂ may be 8/10 or more and 10/8 or less, or may be 1.

Hereinafter, the “opening diameter D₁” and the “opening diameter D₂” may be collectively referred to as an “opening diameter D”. L/D may be 2 or more and 30 or less, 2 or more and 20 or less, or 5 or more and 10 or less.

The description “recessed portions adjacent to each other” refers to recessed portions that are next to each other and the closest to each other. The “distance L” refers to the length of the shortest line segment connecting the recessed portions adjacent to each other in the main surface S.

Due to the plurality of recessed portions, favorable cracks, which will be described later, are formed when the electrode foil is wound, and the formation of cracks that extend straight from an end portion to another end portion of the foil in the width direction and cause breakage of the foil is suppressed.

When the electrode foil is wound, cracks are formed between the recessed portions, and consequently, stress generated due to the electrode foil being wound is mitigated, and breakage of the electrode foil when it is wound is suppressed. The electrode foil is wound in a step of winding the electrode foil using a roller in the production of a capacitor and a step of forming a wound body, for example.

The cracks are formed in such a manner as to extend from inner walls of the recessed portions as viewed from the main surface S side, and the cracks extending from the recessed portions connect with each other. By forming the group of recessed portions, it is possible to control the length and shape of cracks, the direction in which cracks extend, and the like. Depending on the arrangement of the group of recessed portions, cracks can be formed in such a manner as to slightly curve between the recessed portions in the main surface S.

If the group of recessed portions is not provided, the formation of cracks may progress instantly in the width direction of the foil due to stress generated when the electrode foil is wound in the production of a capacitor, and the electrode foil may break. In contrast, in a wound capacitor element of a capacitor including the electrode foil according to the present disclosure, cracks are formed between the recessed portions of the electrode foil, and breakage of the electrode foil is suppressed. The formation of cracks between the recessed portions of the electrode foil included in the wound capacitor element indicates that the stress generated when the electrode foil was wound in the production of the capacitor was mitigated.

When the capacitor is used by a user, cracks may be formed and the foil may break due to vibration. However, the electrode foil according to the present disclosure can suppress breakage of the electrode foil and the like due to vibration when the capacitor is used, and therefore, can be suitably used in a capacitor that is installed in a vehicle and required to have high reliability to withstand vibration, for example.

In the production of an electrolytic capacitor, a metal foil (sheet) used as a raw material of an electrode foil comes into contact with a treatment liquid (e.g., an etchant or a chemical treatment liquid) and a roller, and uneven portions (or scratches) may be formed in the metal foil. When the electrode foil is wound, stress may concentrate at the uneven portions, and the electrode foil may break. Moreover, a rolled foil (Al raw foil) is commonly used as the metal foil, and the rolled foil commonly has rolling marks generated during its production. There are cases where etching pits are non-uniformly formed under the influence of the rolling marks, localized reduction in the folding endurance occurs, and the electrode foil breaks when it is wound. In contrast, when the electrode foil according to the present disclosure is used, it is possible to suppress breakage of the electrode foil described above.

However, even when the opening diameter of the recessed portions is larger than the opening diameter of the pores in the porous portion, if the opening diameter D is smaller than 2 μm, the above-described cracks are unlikely to be formed, and the folding endurance tends to decrease. Also, if L/D is less than 2, the distance between the recessed portions is short, and the strength of the electrode foil tends to decrease. If L/D is more than 50, the distance between the recessed portions is long, the number of recessed portions per unit area of the main surface S is small, and the effects of the recessed portions tend to be reduced.

D₁, D₂, and L described above are obtained as follows.

An image of the main surface S of the electrode foil is captured with use of a scanning electron microscope (SEM). In the image, openings whose maximum diameter is 2 μm or more are taken to be openings of recessed portions, and two recessed portions that are next to each other and the closest to each other are taken to be recessed portions adjacent to each other. The maximum diameters of the openings of the two recessed portions are determined as D₁ and D₂. Line segments connecting the recessed portions adjacent to each other are drawn, and the length of the shortest line segment among those line segments is determined as L.

Recessed portions that are adjacent to each other may be spaced apart from each other by the distance L in a direction perpendicular to a winding direction in which the metal foil is wound. In the present specification, the “direction perpendicular to the winding direction” refers to a direction having an angle within a range of 65° to 115° with respect to the winding direction. There is no need to align all recessed portions along a certain direction that is perpendicular to the winding direction, and a configuration is also possible in which recessed portions are arranged along different directions satisfying the above-described angle range.

The plurality of recessed portions may be arranged in a staggered manner. In this case, the plurality of recessed portions may be spaced apart from each other by a distance L₁ (μm) in the winding direction in which the metal foil is wound, spaced apart from each other by a distance L₂ (μm) in a direction perpendicular to the winding direction, and spaced apart from each other by a distance L₃ (μm) in a direction oblique to the winding direction. The shortest distance among the distances L₁ to L₃ may be the distance L.

Recessed portions that are adjacent to each other may have circular openings having the same size, and one recessed portion of the adjacent recessed portions may be provided in the winding direction of the metal foil with respect to the other recessed portion of the adjacent recessed portions. In this case, the distance L may be 15 μm or more and 250 μm or less. Note that the description “provided in the winding direction” means not only a case in which the recessed portions adjacent to each other are provided along the winding direction of the metal foil but also a case in which the one recessed portion is shifted in a direction perpendicular to the winding direction from a position that is in the winding direction as viewed from the other recessed portion, by a length equal to or shorter than the length of the one recessed portion. The above description “having the same size” means that D₁/D₂ falls within a range of 6/10 or more and 10/6 or less. D₁/D₂ may be 8/10 or more and 10/8 or less, or may be 1.

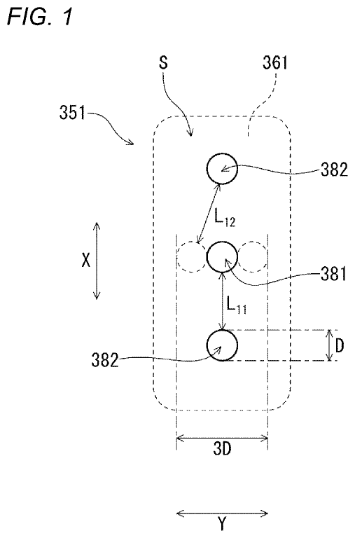

Here, FIG. 1 is a front view showing a main part of an example of an electrode foil according to an embodiment of the present disclosure. The X direction and the Y direction in FIG. 1 respectively indicate the length direction (winding direction) and the width direction of the band-shaped electrode foil. Although a plurality of recessed portions are distributed in a main surface S (the X direction and the Y direction) of an electrode foil 351, FIG. 1 shows a region of the electrode foil 351 including recessed portions arranged in the X direction. As shown in FIG. 1, recessed portions 381 and 382 adjacent to each other are provided in the main surface S of the electrode foil 351 (a porous portion 361). The recessed portions 381 and 382 have circular openings having the same opening diameter D. The opening diameter D is 2 μm or more. The recessed portions 381 and 382 adjacent to each other are provided along the X direction. That is, one recessed portion 381 is provided in the X direction with respect to the other recessed portion 382, and spaced apart from the recessed portion 382 by a distance L₁₁.

The one recessed portion 381 may be slightly shifted in the Y direction (direction perpendicular to the winding direction) from the position that is in the X direction as viewed from the other recessed portion 382 by a length equal to or shorter than the length (opening diameter D) of the one recessed portion 381. For example, the one recessed portion 381 may be shifted from the position in the X direction as viewed from the other recessed portion 382 to the positions of circles drawn with dotted lines (in the Y direction by the length of the one recessed portion 381), and spaced apart from the other recessed portion 382 by a distance L₁₂.

L₁₁/D (or L₁₂/D) is 2 or more and 50 or less. L₁₁ (or L₁₂) may be 15 μm or more and 250 μm or less. When L₁₁ (or L₁₂) described above is 15 μm or more and the metal foil is a rolled foil rolled in the X direction, the strength of the metal foil in the rolling direction is secured even when a group of recessed portions is arranged in the rolling direction. Also, in this case, cracks are likely to be formed in the Y direction when the metal foil is wound, and the cracks formed in the Y direction can be appropriately distributed in the X direction.

The metal foil may be a rolled foil, and the winding direction in which the metal foil is wound may be parallel to the rolling direction of the rolled foil. In this case, the influence of rolling marks when the metal foil is wound can be reduced when compared with a case where the metal foil is wound in a direction perpendicular to the rolling direction. Note that the description “the winding direction is parallel to the rolling direction of the rolled foil” means that an angle formed between the winding direction and the rolling direction is within a range from −20° to 20°.

A depth H (μm) of the recessed portions and a thickness T (μm) of the porous portion (on each side of the electrode foil) preferably satisfy a relationship: 0.05≤H/T≤1.2. Note that the “depth H of a recessed portion” refers to the distance from the opening of the recessed portion to the bottom of the recessed portion. H/T may be 0.1 or more and 1.1 or less, 0.2 or more and 1.1 or less, or 0.5 or more and 1 or less. When H/T is 0.05 or more (or 0.2 or more), the folding endurance of the electrode foil tends to be secured. When H/T is 1.2 or less (or 1.0 or less), the strength of the electrode foil (core portion) tends to be secured. H/T may be larger than 1 and 1.2 or less. That is, the recessed portions may further extend from the porous portion to the core portion as long as the strength of the electrode foil (core portion) is secured. In this case, a depth h of the recessed portions in the core portion is 7 μm or less, for example, and may be 4 μm or less.

The depth H of the recessed portions is determined by measuring the distance from the openings of the recessed portions to the bottoms of the recessed portions in an SEM image of a cross section of the electrode foil. The thickness T of the porous portion is determined by measuring the thickness of the porous portion at 10 arbitrarily selected points on the porous portion in an SEM image of a cross section of the electrode foil taken along the thickness direction, and calculating the average of the measured values.

The diameter of the recessed portions may be larger on the main surface side than on the core portion side. For example, when the opening diameter of a recessed portion is denoted by D, the recessed portion may have a diameter of 0.8 D or less, or 0.05 D or more and 0.8 D or less in the direction in which the opening diameter D is measured, at a depth of D from the opening of the recessed portion.

From the viewpoint of improving the tensile strength and the folding endurance, the recessed portions may extend obliquely with respect to the main surface S. From the viewpoint of easily forming the recessed portions, the recessed portions may extend perpendicularly to the main surface S. Note that the description “extending perpendicularly to the main surface S” means that the recessed portions extend at an angle of 80° to 100° with respect to the main surface S.

When the maximum diameter and the minimum diameter of the opening of a recessed portion are denoted by D_{L} and D_{S}, respectively, the ratio D_{S}/D_{L} of the minimum diameter D_{S} to the maximum diameter D_{L} of the opening of the recessed portion may be 0.05 or more and 1 or less, or 0.2 or more and 1 or less, for example.

Examples of the shape of the recessed portions include columnar shapes (for example, a circular column shape, an elliptical column shape, and polygonal column shapes such as a rectangular column shape), cone or pyramid shapes (for example, a cone shape and pyramid shapes such as a quadrangular pyramid shape), and truncated cone or pyramid shapes (for example, a truncated cone shape and truncated pyramid shapes such as a truncated quadrangular pyramid shape).

From the viewpoint of increasing the folding endurance of the electrode foil, the opening diameter D of the recessed portions is preferably 4 μm or more, and more preferably 8 μm or more. From the viewpoint of improving the folding endurance and securing the tensile strength of the electrode foil, the opening diameter of the recessed portions is preferably 120 μm or less, more preferably 100 μm or less, and further preferably 80 μm or less. The above-described upper limits and lower limits of the opening diameter of the recessed portions may be combined suitably. For example, the opening diameter of the recessed portions may be 2 μm or more and 120 μm or less, 4 μm or more and 120 μm less, or 8 μm or more and 100 μm or less. The opening diameter D (μm) of the recessed portions and a thickness F (μm) of the electrode foil preferably satisfy a relationship: D/F<0.5, and more preferably satisfy a relationship: D/F<0.25 (or 0.2 ).

The plurality of recessed portions are preferably arranged regularly in the in-plane direction of the metal foil. The plurality of recessed portions are preferably arranged at equal intervals in the in-plane direction of the metal foil. The plurality of recessed portions may be arranged in a staggered manner or in a square lattice pattern in the in-plane direction of the metal foil. In a case where two porous portions are provided in such a manner as to sandwich the core portion, the two porous portions may be the same as each other or different from each other in the opening diameter D of the recessed portions, the distance L between the recessed portions, the shape of the recessed portions, the arrangement of the recessed portions, or the like.

Examples of the shape of the openings of the recessed portions include circular shapes, elliptical shapes, polygonal shapes, star shapes, and drop shapes. It is preferable that at least one corner of a polygonal shape is rounded, and it is more preferable that all corners of a polygonal shape are rounded. The openings of the plurality of recessed portions provided in the porous portion may have the same shape or different shapes. The polygonal shapes include triangular shapes, rectangular shapes, hexagonal shapes, and the like. The star shapes include shapes having interior angles of 180° or more, and representative star shapes are star polygons such as a hexagram and a pentagram. A plurality of sides constituting a star shape may be the same as each other or different from each other.

The porous portion may be formed on one surface of the metal foil, or on both surfaces of the metal foil. When the porous portion is formed on both surfaces of the metal foil, the group of recessed portions may be provided at one surface of the metal foil, or both surfaces of the metal foil.

### Electrode Foil

The metal foil used for the electrode foil contains a valve action metal such as aluminum (Al), tantalum (Ta), or niobium (Nb), for example. The metal foil may contain the valve action metal as an alloy or a compound containing the valve action metal. The core portion and the porous portion of the metal foil may be formed as a single piece. For example, the porous portion is formed by roughening a surface of the metal foil containing the valve action metal through etching. The porous portion is an outer portion of the metal foil that includes many pores formed through etching, and the core portion is the remaining inner portion of the metal foil. A band-shaped metal foil is used for the electrode foil, for example, and the width of the metal foil is 1.5 mm or more and 520 mm or less, for example.

The thickness T of the porous portion is not particularly limited, and can be selected as appropriate in accordance with an intended use or a required withstand voltage of the electrolytic capacitor, for example. The thickness T of each porous portion may be 1/10 or more and 5/10 or less of the thickness of the metal foil, for example. In the case of an anode foil, the thickness T of the porous portion is 10 μm or more and 160 μm or less, for example, and may be 50 μm or more and 160 μm or less.

The metal foil includes a metal framework that constitutes the porous portion. The metal framework is a metal portion that has a microstructure in the porous portion. The porous portion includes a plurality of pores (pits) surrounded by the metal framework. From the viewpoint of increasing the surface area and forming a dielectric layer in deep portions of the porous portion, the pore diameter (opening diameter) is less than 2000 nm, and may be 100 nm or more and 1500 nm or less.

The pores (pits) may be sponge-like pits or tunnel-like pits. Tunnel-like pits include pits that extend in the direction from the surface of the porous portion toward the core portion.

In the case of sponge-like pits, the pore diameter (opening diameter) is 600 nm or less, for example, and may be 50 nm or more and 500 nm or less. In the case of sponge-like pits, an average pore diameter Dp may be 80 nm or more and 400 nm or less, or 100 nm or more and 300 nm or less. An electrode foil including sponge-like pits is used for a low-voltage electrolytic capacitor, for example. Specifically, such an electrode foil is used for an electrolytic capacitor in which a chemical conversion foil that withstands a voltage of 200 V or less is used. In the case of tunnel-like pits, the pore diameter (opening diameter) is 1900 nm or less, for example, and may be 100 nm or more and 1800 nm or less. In the case of tunnel-like pits, an average pore diameter Dp may be 200 nm or more and 1700 nm or less, or 400 nm or more and 1400 nm or less. An electrode foil including tunnel-like pits is used for a medium to high voltage electrolytic capacitor in which a chemical conversion foil that withstands a voltage of 180 V or more is used, for example.

The average pore diameter Dp in the porous portion is determined by measuring a pore diameter distribution in the electrode foil (porous portion) with use of a mercury porosimeter. Specifically, a pore diameter (mode diameter) corresponding to a peak (in a case where there is a plurality of peaks, the largest peak) in a pore distribution curve (vertical axis: log differential pore volume, horizontal axis: pore diameter) obtained through the measurement is taken as the average pore diameter Dp. The average pore diameter Dp is measured using the AutoPore V series manufactured by Micromeritics, for example.

The pore distribution curve described above shows a distribution of pores having a pore diameter smaller than 2 μm in the porous portion. Commonly, the recessed portions have a very large diameter (opening diameter) compared with the pores in the porous portion, and it is difficult to measure the diameter of the recessed portions with use of the mercury porosimeter under the same conditions as those under which the porous portion is measured.

The electrode foil may include a dielectric layer that covers the metal framework constituting the porous portion including the group of recessed portions. In this case, the electrode foil can be used as an anode foil. The dielectric layer covers at least a portion of an outer surface (the main surface S) of the porous portion and a portion of inner wall surfaces of the pores and the recessed portions in the porous portion. That is, the dielectric layer is provided in such a manner as to cover at least a portion of the surface of the metal framework surrounding the pores and the recessed portions.

The thickness F of the metal foil (electrode foil) may be 10 μm or more, 60 μm or more, or 80 μm or more (or 100 μm or more). When the thickness F of the metal foil is 80 μm or more (or 100 μm or more), large stress is generated when the metal foil is wound, and accordingly, the effect of mitigating the stress by forming cracks between the recessed portions is noticeable.

The thickness of the dielectric layer may be 2 nm or more, 4 nm or more, 12 nm or more, or 24 nm or more. An electrode foil that includes a dielectric layer having a thickness of 24 nm or more can be used as an anode foil in an electrolytic capacitor whose rated voltage is 20 V or more. Particularly when the electrode foil is used in a hybrid capacitor, it is preferable to form a dielectric layer with a thickness of 50 nm or more, and the formation voltage at the time of chemical conversion treatment is preferably 30 V or more. When the formation voltage is as high as 30 V or more, the dielectric layer becomes thick and a problem in terms of the strength of the electrode foil is likely to occur, and accordingly, the effect of mitigating stress by forming cracks between the recessed portions is large. The thickness of the dielectric layer is determined by measuring the thickness of the dielectric layer at 10 arbitrarily selected points on the dielectric layer with use of a cross-sectional image of the electrode foil taken along the thickness direction with use of an SEM or a transmission electron microscope (TEM), and calculating the average of the measured values.

### Method for Producing Electrode Foil

A method for producing the electrode foil according to the present embodiment includes a step of etching the metal foil and a step of forming the group of recessed portions in the etched foil, for example. In the etching step, a surface of the metal foil containing a valve action metal is roughened by being etched to form the porous portion that is continuous to the core portion. Either electrolytic etching or chemical etching may be performed.

It is possible to mass-produce electrode foils that include porous portions including pores having a diameter (opening diameter) smaller than 2 μm through electrolytic etching. In the case of AC etching, it is possible to produce an electrode foil that includes a porous portion including sponge-like pits having a diameter of 1.5 μm or less. In the case of DC etching, it is possible to produce an electrode foil that includes a porous portion including tunnel-like pits having a diameter smaller than 2 μm. AC etching is preferable because it is easy to make a large difference between the opening diameter of the pores and the opening diameter of the recessed portions in the porous portion.

In the step of forming the group of recessed portions, the group of recessed portions may be formed by pressing a jig including a plurality of protrusions against the metal foil having the roughened surface. Alternatively, it is also possible to form groups of recessed portions on both surfaces of the metal foil that have been roughened, by conveying the metal foil between a pair of rollers including a plurality of protrusions and pressing the pair of rollers against the metal foil. The groups of recessed portions may also be formed through laser processing, blasting, etching, or the like.

The method for producing the electrode foil may also include a step of forming slits in the etched foil. For example, a band-shaped etched foil having a width of 500 mm is divided into sections having a width of 1.5 mm or more and 40 mm or less by forming slits in the foil. The slits may be formed before or after the step of forming the group of recessed portions (or after a step of forming a dielectric layer). After the slits are formed, the metal foil may be wound with use of a roller. When a slitting width is as small as 10 mm or less, the metal foil may break due to stress generated in the metal foil when the metal foil is wound with use of the roller, but the breakage of the metal foil is suppressed if the step of winding the metal foil with use of the roller is performed after the step of forming the group of recessed portions.

The method for producing the electrode foil may also include a step of forming a dielectric layer that covers the metal framework constituting the porous portion including the group of recessed portions. The dielectric layer may be formed before or after the step of forming the group of recessed portions. In the step of forming a dielectric layer, an oxide film containing the valve action metal may be formed on the surface of the metal foil including the porous portion (porous portion including the group of recessed portions) through anodization (chemical conversion treatment).

The electrode foil for an electrolytic capacitor according to the present embodiment may be used as at least one of an anode foil and a cathode foil in a wound electrolytic capacitor or an anode body in a stacked electrolytic capacitor.

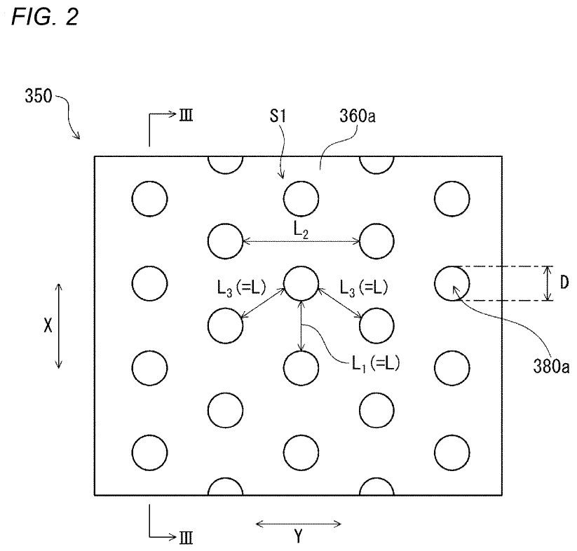

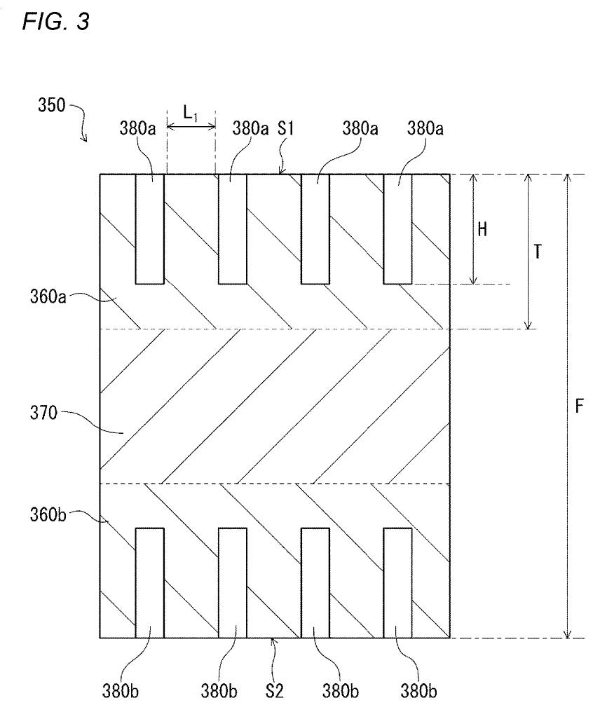

Here, FIG. 2 is a front view schematically showing another example of an electrode foil for an electrolytic capacitor according to an embodiment of the present disclosure. A band-shaped electrode foil 350 (metal foil) shown in FIG. 2 has a first main surface S1 and a second main surface S2 that is opposite to the first main surface S1. FIG. 2 shows a portion of the electrode foil 350 as viewed from the first main surface S1 side. The X direction and the Y direction in FIG. 2 respectively indicate the length direction and the width direction of the band-shaped electrode foil. FIG. 3 is a cross-sectional view taken along the line III-III shown in FIG. 2. FIG. 3 schematically shows a cross section of the electrode foil 350 shown in FIG. 2, which is taken along the thickness direction and viewed in the Y direction. Note that the electrode foil for an electrolytic capacitor according to the present disclosure is not limited to the electrode foil shown in FIGS. 2 and 3. The drawings are schematic drawings, and ratios between dimensions of the components (for example, a ratio between the size of recessed portions and the distance between the recessed portions) may be different from actual ratios.

The band-shaped electrode foil 350 (metal foil) includes a first porous portion 360a and a core portion 370 that is continuous to the first porous portion 360a. The electrode foil 350 has the first main surface S1 in which pores (not shown) in the first porous portion 360a are open. The first porous portion 360a includes a plurality of recessed portions 380a that are open in the first main surface S1 and have a circular column shape. The plurality of first recessed portions 380a are spaced apart from each other and distributed in a dot pattern in in-plane directions (the X direction and the Y direction) of the electrode foil 350. The pores in the first porous portion 360a have an opening diameter smaller than 2 μm. When the electrode foil 350 is a rolled foil, it is desirable that the X direction is the rolling direction.

As shown in FIG. 2, the plurality of first recessed portions 380a are arranged at equal intervals in a staggered manner. First recessed portions 380a that are adjacent to each other are spaced apart from each other by a distance L. The plurality of first recessed portions 380a have circular openings having an opening diameter D (μm). The opening diameter D of the first recessed portions 380a is 2 μm or more. L/D is 2 or more and 50 or less. In this case, when the electrode foil is wound in the X direction, favorable cracks are formed between the first recessed portions 380a, stress generated due to the electrode foil being wound is mitigated, the folding endurance in the Y direction is increased, and breakage of the electrode foil when it is wound is suppressed.

The plurality of first recessed portions 380a are spaced apart from each other by a distance L₁ (μm) in the winding direction (X direction) in which the metal foil is wound, spaced apart from each other by a distance L₂ (μm) in a direction (Y direction) perpendicular to the winding direction, and spaced apart from each other by a distance L₃ (μm) in a direction oblique to the winding direction (X direction). L₁ and L₃ are the same as each other and smaller than L₂, and correspond to the distance L. That is, L₁/D and L₃/D are 2 or more and 50 or less. The distance L₁ and the distance L₂ satisfy a relationship: 2<L₂/L₁. In this case, the folding endurance in the Y direction increases significantly. Particularly in a case where a large stress is generated in the Y direction, the effect of mitigating stress by forming cracks between the recessed portions is noticeable. Examples of such a case include: a case where slits are formed in the electrode foil; a case where the electrode foil is curved or an angle of a conveying direction of the electrode foil is changed while the electrode foil is conveyed; a case where the electrode foil is formed into a wound body; and a case where a sealing member is placed in an opening of a bottomed case in which the wound body provided with leads is housed, and the opening of the bottomed case is swaged.

In FIG. 2, L₁ and L₃ are the same as each other, but the arrangement of the recessed portions may be adjusted in such a manner that L₁ is smaller than L₃ or L₁ is smaller than L₃. In particular, the relationship: L₁>L₃ is desirable.

Cracks are likely to be formed in the direction of L₂ (Y direction) shown in FIG. 2 when the metal foil is wound in the X direction. Depending on the distance L₁, it is possible to form cracks mainly in the direction of L₂ (Y direction) shown in FIG. 2, and also form cracks in the direction of L₃ shown in FIG. 2 at a certain proportion. Thus, it is possible to effectively mitigate stress generated due to the metal foil being wound. From this viewpoint, L₁ may be 15 μm or more and 250 μm or less, for example. The cracks are formed in such a manner as to connect 50 to 500 first recessed portions 380a, for example.

The electrode foil 350 has a thickness F (μm). For example, F and D/F fall within the ranges described above as examples. The first porous portion 360a has a thickness T (μm), and the first recessed portions 380a have a depth H (μm). For example, T and H/T fall within the ranges described above as examples.

Openings of the first recessed portions shown in FIG. 2 have a circular shape, but there is no limitation to this configuration. Openings of the recessed portions may have an elliptical shape, a rectangular shape, a hexagonal shape, or the like. The first recessed portions have a circular column shape, but the shape of the first recessed portions is not limited to this example, and may also be a columnar shape other than the circular column shape, a cone shape, a pyramid shape, or the like. The plurality of first recessed portions have the same shape and the same size, but the plurality of first recessed portions may have different shapes and/or different sizes. The arrangement pattern of the first recessed portions is not limited to that shown in FIG. 2, and may be a square lattice pattern, for example. The X direction and the Y direction may also be the width direction and the length direction of the band-shaped electrode foil, respectively. In this case, L₁ and L₂ shown in FIG. 2 are read as L₂ and L₁, respectively. Even when the Y direction is the winding direction, favorable cracks are formed, the folding endurance in the X direction is increased, and breakage of the electrode foil when it is wound is suppressed.

As shown in FIG. 3, the band-shaped electrode foil 350 (metal foil) includes a second porous portion 360b and the core portion 370 that is continuous to the second porous portion 360b. That is, the first porous portion 360a and the second porous portion 360b are arranged in such a manner as to sandwich the core portion 370. The electrode foil 350 has the second main surface S2 in which pores (not shown) in the second porous portion 360b are open.

The porous portion 360b includes a plurality of second recessed portions 380b that are open in the second main surface S2. The first recessed portions 380a and the second recessed portions 380b are the same in the shape, the size, the interval, and the arrangement pattern, but may be different from each other in the shape and the like.

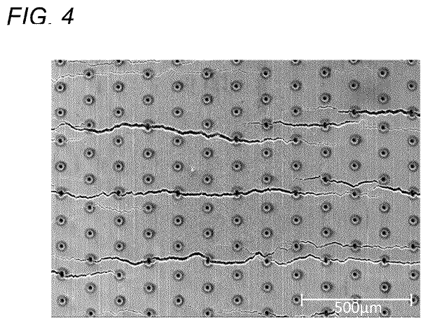

FIG. 4 is an SEM image showing an example of an electrode foil for an electrolytic capacitor according to an embodiment of the present disclosure after the electrode foil was wound. FIG. 4 shows a portion of a surface of the electrode foil. The vertical direction of the image is the longitudinal direction (winding direction) of the band-shaped electrode foil, which is the rolling direction of the electrode foil. A group of recessed portions shown in FIG. 4 is arranged similarly to the group of recessed portions shown in FIG. 2. As shown in FIG. 4, cracks were formed between the recessed portions in a direction perpendicular to the winding direction (rolling direction) when the electrode foil was wound.

### Electrolytic Capacitor

An electrolytic capacitor according to the present disclosure includes a wound body and an electrolyte. The wound body is obtained by winding together an anode foil, a cathode foil arranged opposite to the anode foil, and a separator arranged between the anode foil and the cathode foil. The wound body and the electrolyte will also be collectively referred to as a capacitor element. At least one of the anode foil and the cathode foil includes a metal foil that includes a porous portion and a core portion that is continuous to the porous portion. The metal foil has a main surface in which pores in the porous portion are open. The pores in the porous portion have an opening diameter smaller than 2 μm. The porous portion includes a plurality of recessed portions that are open in the main surface and distributed in a dot pattern in an in-plane direction of the main surface.

In an electrolytic capacitor according to an embodiment of the present disclosure, recessed portions adjacent to each other have an opening diameter D₁ (μm) and an opening diameter D₂ (μm), respectively, and are spaced apart from each other by a distance L (μm). The opening diameter D₁ and the distance L satisfy 2≤D₁ and 2≤L/D₁≤50. The opening diameter D₂ and the distance L satisfy 2≤D₂ and 2≤L/D₂≤50.

In the electrolytic capacitor according to the embodiment of the present disclosure, the metal foil included in the wound body may include cracks between the recessed portions. The cracks are formed in such a manner as to connect the recessed portions, when the metal foil including a group of recessed portions is wound.

Also, in an electrolytic capacitor according to another embodiment of the present disclosure, the recessed portions have an opening diameter of 2 μm or more, and there are cracks between the recessed portions. In the electrolytic capacitor according to the other embodiment of the present disclosure, opening diameters D₁ (μm) and D₂ (μm) of recessed portions adjacent to each other and a distance L (μm) between the recessed portions may satisfy 2≤D₁, 2≤L/D₁≤50, 2≤D₂, and 2≤L/D₂≤50.

Preferably, cracks extend in such a manner as to connect at least two recessed portions in a direction (width direction) perpendicular to the winding direction of the metal foil. Such cracks can be formed when the recessed portions are arranged appropriately (for example, in the staggered manner shown in FIG. 2) so that L/D falls within the range of 2 or more and 50 or less. For example, cracks are formed in such a manner as to connect 2 to 100 recessed portions.

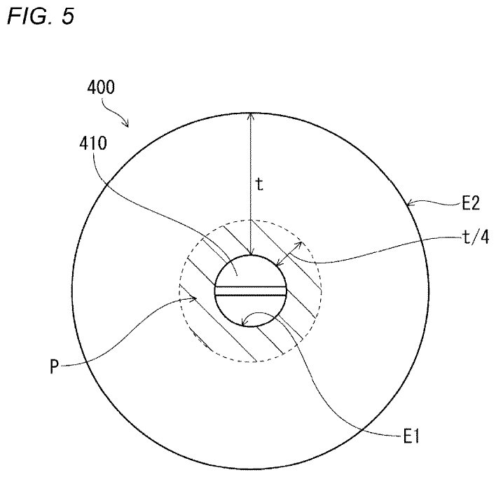

FIG. 5 is a diagram schematically showing an example of the wound body as viewed from an end surface side. A wound body 400 is obtained by winding an anode foil and a cathode foil around a core 410 with a separator arranged between the anode foil and the cathode foil. When the thickness of the wound body 400 in a radial direction from an innermost circumferential surface E1 to an outermost circumferential surface E2 is denoted by t, a “region P” is a region from the innermost circumferential surface E1 of the wound body 400 to an area at a distance of (¼)t in the radial direction.

Cracks may be present at least in the region P of the wound body. More cracks may be present in the region P than in the remaining region of the wound body excluding the region P. Breakage of an electrode foil when the electrode foil is wound tends to occur in the region P in which a large stress is likely to be generated due to the electrode foil being wound. On the other hand, favorable cracks that mitigate the stress are likely to be formed in the region P when the electrode foil is wound. When there are cracks in the region P, breakage of the electrode foil when it is wound can be efficiently suppressed.

When the metal foil has a length L_{W} mm in a direction (width direction) perpendicular to the winding direction of the wound body, the number of recessed portions present per L_{W}² mm² of the main surface may be 30 or more and 25600 or less. In this case, cracks are likely to be formed between the recessed portions when the metal foil is wound, and stress generated when the metal foil is wound is likely to be mitigated by the cracks. L_{W} is substantially equal to a height L_{C} of the wound body. L_{W} may be 30 mm or less, or 10 mm or less, for example. When L_{W} is 30 mm or less, the number of recessed portions per L_{W}² mm² of the main surface may be 1850 or less. When L_{W} is 10 mm or less, the number of recessed portions per L_{W}² mm² of the main surface may be 625 or less.

A metal foil E may be used as at least one of the anode foil and the cathode foil. The metal foil E includes: a first porous portion and a second porous portion arranged in such a manner as to sandwich a core portion; a first main surface in which pores in the first porous portion are open and a second main surface in which pores in the second porous portion are open; and a plurality of recessed portions including a plurality of first recessed portions that are arranged in the first porous portion and open in the first main surface. In this case, stress generated on the first main surface side of the metal foil due to the metal foil being wound is likely to be mitigated by cracks formed between the first recessed portions when the metal foil is wound.

The plurality of recessed portions (group of recessed portions) included in the metal foil E may further include a plurality of second recessed portions that are arranged in the second porous portion and open in the second main surface. In this case, stress generated on the second main surface side of the metal foil due to the metal foil being wound is likely to be mitigated by cracks formed between the second recessed portions when the metal foil is wound.

From the viewpoint of improving the folding endurance, it is preferable that the first recessed portions and the second recessed portions are provided at positions where the first recessed portions and the second recessed portions are not opposite to each other via the core portion.

In the wound body, the metal foil E may be wound in such a manner that the first main surface faces an outer circumferential surface side of the wound body. In the following description, a wound body including the metal foil E wound in such a manner that the first main surface faces the outer circumferential surface side of the wound body will be referred to as a “wound body A”.

In the wound body A, stress generated due to the metal foil E being wound is likely to be larger on the first main surface side (the outer circumferential surface side of the wound body) than on the second main surface side (the inner circumferential surface side of the wound body), and the effect of mitigating the stress by the first recessed portions is noticeable. In a case where a large stress is also generated on the second main surface side due to the metal foil being wound, second recessed portions may also be provided in the second main surface. In the region P of the wound body A, a large stress is generated due to the metal foil being wound, and it is desirable to provide the first recessed portions and the second recessed portions in the region P.

### Anode Foil

The anode foil includes: a metal foil including a porous portion and a core portion continuous to the porous portion; and a dielectric layer covering the porous portion. The porous portion is formed by roughening a surface of the metal foil containing a valve action metal through etching, for example. Examples of the valve action metal include aluminum (Al), tantalum (Ta), and niobium (Nb). The metal foil may contain the valve action metal as an alloy or a compound containing the valve action metal.

The dielectric layer is obtained by forming an oxide film containing the valve action metal on the roughened surface of the metal foil through anodization (chemical conversion treatment). The formation voltage of chemical conversion treatment performed on an Al foil may be 4 V or more, or 40 V or more, for example.

The thickness of the anode foil may be 60 μm or more and 200 μm or less, for example, and may be 80 μm or more (or 100 μm or more) and 200 μm or less. A thick anode foil tends to be used as the capacitance becomes larger. In the case of an anode foil having a high capacitance and a thickness of 100 μm or more, for example, the effect of mitigating stress by forming cracks between recessed portions is noticeable.

### Cathode Foil

A metal foil that contains a valve action metal such as Al, Ta, or Nb can be used as the cathode foil. A surface of the metal foil may be roughened through etching as necessary. That is, the cathode foil may be a metal foil that includes a porous portion and a core portion continuous to the porous portion. The thickness of the cathode foil is 10 μm or more and 70 μm or less, for example.

### Separator

The separator is not particularly limited. For example, it is possible to use nonwoven cloth containing fibers made of cellulose, polyethylene terephthalate, vinylon, or polyamide (for example, aliphatic polyamide or aromatic polyamide such as aramid).

### Electrolyte

The electrolyte covers at least a portion of the anode foil (the dielectric layer), and is interposed between the anode foil (the dielectric layer) and the cathode foil. The electrolyte includes at least one of a solid electrolyte and a liquid electrolyte. When the electrolyte includes a solid electrolyte, the electrolytic capacitor may include the solid electrolyte and a liquid electrolyte, or include the solid electrolyte and a nonaqueous solvent. In the following description, the liquid electrolyte and the nonaqueous solvent will also be collectively referred to as a “liquid component”.

The solid electrolyte contains a conductive polymer. The conductive polymer is a π-conjugated polymer, for example. Examples of the conductive polymer include polypyrrole, polythiophene, polyfuran, and polyaniline. It is possible to use one type of conductive polymer alone, two or more types of conductive polymers in combination, or a copolymer of two or more monomers. The conductive polymer has a weight-average molecular weight of 1000 to 100000, for example.

Note that polypyrrole, polythiophene, polyfuran, polyaniline, and the like referred to in the present specification respectively mean polymers that include polypyrrole, polythiophene, polyfuran, polyaniline, and the like as the basic structure. Accordingly, the terms polypyrrole, polythiophene, polyfuran, polyaniline, and the like also encompass derivatives of those polymers. For example, the term polythiophene encompasses poly(3,4-ethylenedioxythiophene), for example.

The conductive polymer can be doped with a dopant. The solid electrolyte may contain a dopant together with the conductive polymer. Examples of the dopant include polystyrene sulfonic acid. The solid electrolyte may further contain an additive as necessary.

The liquid component is in contact with the dielectric layer directly or via the conductive polymer. The liquid component may be a nonaqueous solvent or a liquid electrolyte (electrolyte solution). The electrolyte solution contains a nonaqueous solvent and an ionic material (a solute (for example, an organic salt)) dissolved in the nonaqueous solvent. The nonaqueous solvent may be an organic solvent or an ionic liquid.

A solvent that has a high boiling point is preferably used as the nonaqueous solvent. For example, it is possible to use polyol compounds such as ethylene glycol, sulfone compounds such as sulfolane, lactone compounds such as γ-butyrolactone, ester compounds such as methyl acetate, carbonate compounds such as propylene carbonate, ether compounds such as 1,4-dioxane, and ketone compounds such as methylethylketone.

The liquid component may contain an acid component (anion) and a base component (cation). A salt (solute) may be formed by the acid component and the base component. The acid component contributes to a coating film repair function. Examples of the acid component include organic carboxylic acids and inorganic acids. Examples of inorganic acids include phosphoric acid, boric acid, and sulfuric acid. Examples of the base component include primary to tertiary amine compounds.

An organic salt is a salt in which at least one of the anion and the cation includes an organic substance. Examples of organic salts that can be used include trimethylamine maleate, triethylamine borodisalicylate, ethyldimethylamine phthalate, mono-1,2,3,4-tetramethylimidazolinium phthalate, and mono-1,3-dimethyl-2-ethylimidazolinium phthalate.

From the viewpoint of suppressing de-doping of the dopant from the conductive polymer (deterioration of the solid electrolyte), the liquid component preferably contains the acid component more than the base component. Also, the acid component contributes to the coating film repair function of the liquid component, and therefore, the liquid component preferably contains the acid component more than the base component. The molar ratio (acid component/base component) of the acid component to the base component is 1.1 or more, for example. From the viewpoint of suppressing de-doping of the dopant from the conductive polymer, for example, pH of the liquid component may be 6 or less, or 1 or more and 5 or less.

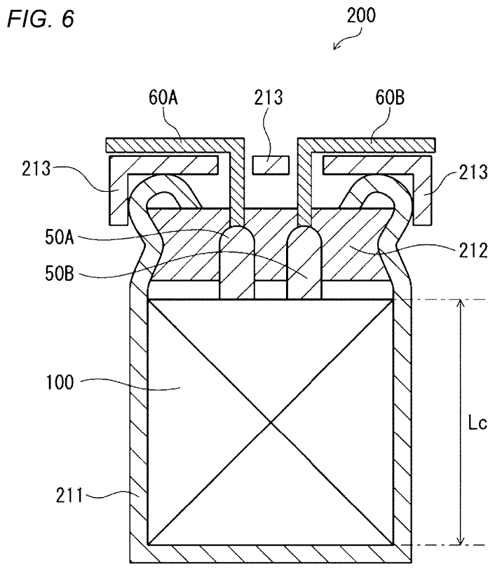

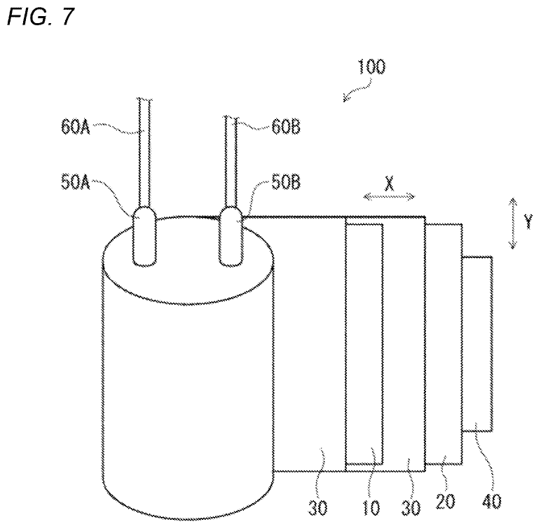

Here, FIG. 6 is a cross-sectional view schematically showing an electrolytic capacitor according to an embodiment of the present disclosure. FIG. 7 is a perspective view schematically showing the configuration of a wound body shown in FIG. 6. In FIG. 7, the X direction indicates the length direction of a band-shaped anode foil 10 and a band-shaped cathode foil 20, and the Y direction indicates the width direction of the anode foil 10 and the cathode foil 20.

An electrolytic capacitor 200 includes a wound body 100. The wound body 100 is obtained by winding together the anode foil 10 and the cathode foil 20 with a separator 30 arranged therebetween. An electrode foil according to an embodiment of the present disclosure is used as at least one of the anode foil 10 and the cathode foil 20. The wound body 100 has a height L_{C} that is substantially equal to the lengths of the anode foil 10 and the cathode foil 20 in the width direction (Y direction).

End portions of lead tabs 50A and 50B are connected to the anode foil 10 and the cathode foil 20, respectively, and the wound body 100 is formed by winding the electrode foils to which the lead tabs 50A and 50B are connected. Lead wires 60A and 60B are connected to other end portions of the lead tabs 50A and 50B, respectively.

A winding end tape 40 is provided on the outer surface of a portion of the cathode foil 20 constituting the outermost layer of the wound body 100, and an end portion of the cathode foil 20 is fixed with the winding end tape 40. In a case where the anode foil 10 is prepared by cutting a large foil, chemical conversion treatment may be further performed on the wound body 100 to provide a dielectric layer on the cut cross section.

The wound body 100 contains an electrolyte between the anode foil 10 (dielectric layer) and the cathode foil. The wound body 100 containing the electrolyte is obtained by impregnating the wound body 100 with a treatment solution containing the electrolyte, for example. The impregnation may be carried out in an atmosphere having a reduced pressure of 10 kPa to 100 kPa, for example. The treatment solution may contain a solid electrolyte and either an electrolyte solution or a nonaqueous solvent.

The wound body 100 is housed in a bottomed case 211 in such a manner that the lead wires 60A and 60B are located on the opening side of the bottomed case 211. The bottomed case 211 may be made of metal such as aluminum, stainless steel, copper, iron, or brass, or an alloy of any of these metals.

A sealing member 212 is arranged in the opening of the bottomed case 211 in which the wound body 100 is housed, the open end of the bottomed case 211 is swaged on the sealing member 212 to be curled, and a base plate 213 is arranged on the curled portion to seal the wound body 100 in the bottomed case 211.

The sealing member 212 is formed in such a manner that the lead wires 60A and 60B extend therethrough. The sealing member 212 is only required to be made of an insulating material, and is preferably constituted by an elastic member. In particular, it is preferable to use silicone rubber, fluororubber, ethylene propylene rubber, Hypalon rubber, butyl rubber, isoprene rubber, or the like, which has high heat resistance.

### EXAMPLES

The following describes the present disclosure in more detail based on examples and comparative examples, but the present disclosure is not limited to the examples.

### Examples 1 to 7 and Comparative Examples 1 and 2

A band-shaped electrode foil shown in FIG. 2 was produced as follows. First, a band-shaped Al foil having a thickness of 120 μm was prepared. The Al foil was a rolled foil of which the rolling direction was parallel to the length direction (X direction). Both surfaces of the Al foil were roughened through etching. Thus, porous portions (thickness T: 45 μm, average pore diameter Dp: 0.2 μm) including sponge-like pits were formed at both surfaces of the Al foil. A plurality of recessed portions (depth H: 45 μm) having a circular column shape were formed in both surfaces of the Al foil with use of a predetermined jig to provide groups of recessed portions arranged in a staggered manner as shown in FIG. 2 in both surfaces of the Al foil. The opening diameter D of the recessed portions and the distance L between the recessed portions shown in FIG. 2 were set as shown in Table 1. The number of recessed portions per L_{W}² (mm²) of each main surface of the metal foil was as shown in Table 1. Thus, each of electrode foils a1 to a7, b1, and b2 was obtained. The electrode foils a1 to a7 correspond to Examples 1 to 7, respectively, and the electrode foils b1 and b2 correspond to Comparative Examples 1 and 2, respectively.

### Comparative Example 3

An electrode foil b3 was obtained in the same manner as the electrode foil a1, except that the plurality of recessed portions were not formed in both surfaces of the aluminum foil.

The electrode foils of Examples and Comparative Examples obtained as described above were each evaluated as follows.

### Evaluation: Folding Endurance

The electrode foil was sampled along the X direction to obtain a band-shaped sample piece (length direction: 100 mm, width direction: 10 mm). The folding endurance of the sample piece in the width direction (Y direction) was measured. The measurement was carried out in accordance with a test method (EIAJ RC-2364A) for electrode foils for aluminum electrolytic capacitors specified in standards of the Electronic Industries Association of Japan. The folding endurance was expressed as a relative value with the folding endurance of the electrode foil b3 of Comparative Example 3 taken as 100. Evaluation results are shown in Table 1.

TABLE 1

| | | | | Number of | | |
|---|---|---|---|---|---|---|
| | | | | recessed | | |
| | | | | portions | | |
| | Opening | Distance | | per | | |
| | diameter | L | | Lw²(mm²) | | |
| | D of | between | | of main | | Folding |
| | recessed | recessed | | surface of | | endurance |
| Electrode | portions | portions | | electrode | | (relative |
| foil | (μm) | (μm) | L/D | foil | H/T | value) |
| b3 | — | — | — | — | — | 100 |
| b1 | 18 | 27 | 1.5 | 494 | 1.0 | 108 |
| a1 | 25 | 50 | 2 | 178 | 1.0 | 118 |
| a2 | 25 | 125 | 5 | 45 | 1.0 | 130 |
| a3 | 25 | 200 | 8 | 20 | 1.0 | 139 |
| a4 | 30 | 180 | 6 | 23 | 1.0 | 144 |
| a5 | 30 | 300 | 10 | 10 | 1.0 | 120 |
| a6 | 30 | 900 | 30 | 2 | 1.0 | 115 |
| a7 | 18 | 900 | 50 | 2 | 1.0 | 112 |
| b2 | 18 | 990 | 55 | 1 | 1.0 | 105 |

The electrode foils al to a7 had higher degrees of folding endurance than the electrode foils b1 to b3.

### Examples 8 to 15

Electrode foils a8 to a15 were produced in the same manner as the electrode foil a4, except that the depth H of the recessed portions was changed such that H/T was as shown in Table 2, and the obtained electrode foils were evaluated. Evaluation results are shown in Table 2.

TABLE 2

| | | | | Number of | | |
|---|---|---|---|---|---|---|
| | | | | recessed | | |
| | | | | portions | | |
| | Opening | Distance | | per | | |
| | diameter | L | | Lw²(mm²) | | |
| | D of | between | | of main | | Folding |
| | recessed | recessed | | surface of | | endurance |
| Electrode | portions | portions | | electrode | | (relative |
| foil | (μm) | (μm) | L/D | foil | H/T | value) |
| a8 | 30 | 180 | 6 | 23 | 0.02 | 109 |
| a9 | 30 | 180 | 6 | 23 | 0.05 | 111 |
| a10 | 30 | 180 | 6 | 23 | 0.25 | 123 |
| a11 | 30 | 180 | 6 | 23 | 0.5 | 147 |
| a12 | 30 | 180 | 6 | 23 | 0.75 | 145 |
| a4 | 30 | 180 | 6 | 23 | 1 | 144 |
| a13 | 30 | 180 | 6 | 23 | 1.05 | 133 |
| a14 | 30 | 180 | 6 | 23 | 1.2 | 113 |
| a15 | 30 | 180 | 6 | 23 | 1.3 | 103 |

All of the electrode foils a4 and a8 to a15 had high degrees of folding endurance. In particular, the electrode foils a4 and a9 to a14 in which H/T was 0.05 or more and 1.2 or less had excellent folding endurance.

Furthermore, the electrode foil a4 was sampled along the Y direction to obtain a band-shaped sample piece, and the folding endurance of the sample piece in the width direction (X direction) was measured. The result is shown in Table 3. Table 3 also shows the measurement result shown in Table 1, which is the result of the case where the electrode foil a4 was sampled along the X direction.

TABLE 3

| | Electrode foil | | | | |
|---|---|---|---|---|---|
| | | | Arrangement | | |
| | Inspection | | pattern of | | Folding |
| | direction | | group of | | endurance |
| Electrode | (sampling | Rolling | recessed | | (relative |
| foil | direction) | direction | portions | L/D | value) |
| a4 | X | X | FIG. 2 | 10 | 144 |
| a4 | Y | X | FIG. 2 | 10 | 120 |

The folding endurance in the Y direction was higher than the folding endurance in the X direction.

### Industrial Applicability

An electrode foil according to the present disclosure is suitably used for an electrolytic capacitor for which high reliability is required.

Although the presently preferred embodiments of the present invention have been described, such a disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications that fall within the true spirit and scope of the invention.

### REFERENCE SIGNS LIST

10: anode foil, 20: cathode foil, 30: separator, 40: winding end tape; 50A, 50B: lead tab, 60A, 60B: lead wire, 100, 400: wound body, 200: electrolytic capacitor, 211: bottomed case, 212: sealing member, 213: base plate, 350, 351: electrode foil, 360a: first porous portion, 360b: second porous portion, 361: porous portion, 370: core portion, 380a: first recessed portion, 380b: second recessed portion, 381, 382: recessed portion, 410: core

1. An electrode foil for an electrolytic capacitor, comprising:
a metal foil that includes a porous portion and a core portion that is continuous to the porous portion,
wherein the metal foil has a main surface in which pores in the porous portion are open,
the porous portion includes a plurality of recessed portions that are open in the main surface and distributed in a dot pattern in an in-plane direction of the main surface,
the pores in the porous portion have an opening diameter smaller than 2 μm,
recessed portions that are adjacent to each other among the recessed portions have opening diameters D₁ μm and D₂ μm, respectively, and are spaced apart from each other by a distance L μm,
the opening diameter D₁ and the distance L satisfy 2≤D₁ and 2≤L/D₁≤50, and
the opening diameter D₂ and the distance L satisfy 2≤D₂ and 2≤L/D₂≤50.

2. The electrode foil for an electrolytic capacitor according to claim 1,
wherein the recessed portions adjacent to each other are spaced apart from each other by the distance L in a direction perpendicular to a winding direction in which the metal foil is wound.

3. The electrode foil for an electrolytic capacitor according to claim 1,
wherein the plurality of recessed portions are arranged in a staggered manner,
spaced apart from each other by a distance L₁ μm in a winding direction in which the metal foil is wound,
spaced apart from each other by a distance L2 μm in a direction perpendicular to the winding direction, and
spaced apart from each other by a distance L₃ μm in a direction oblique to the winding direction, and
the shortest distance of the distances L₁ to L₃ is the distance L.

4. The electrode foil for an electrolytic capacitor according to claim 3,
wherein the distance L₁ and the distance L₂ satisfy 2<L₂/L₁, and
the shortest distance of the distances L₁ and L₃ is the distance L.

5. The electrode foil for an electrolytic capacitor according to claim 1,
wherein the recessed portions adjacent to each other have circular openings having the same size,
out of the recessed portions adjacent to each other, one recessed portion is provided in a winding direction of the metal foil with respect to the other recessed portion, and
the distance L is 15 μm or more and 250 μm or less.

6. The electrode foil for an electrolytic capacitor according to claim 2,
wherein the metal foil is a rolled foil, and
the winding direction is parallel to a rolling direction of the rolled foil.

7. The electrode foil for an electrolytic capacitor according to claim 1,
wherein a depth H μm of the recessed portions and a thickness T μm of the porous portion has a relationship: 0.05≤H/T≤1.2.

8. The electrode foil for an electrolytic capacitor according to claim 1,
wherein a diameter of the recessed portions is larger on the main surface side than on the core portion side.

9. The electrode foil for an electrolytic capacitor according to claim 1, further comprising
a dielectric layer that covers a metal framework constituting the porous portion including the plurality of recessed portions.

10. An electrolytic capacitor comprising:
a wound body; and
an electrolyte,
wherein the wound body is obtained by winding together an anode foil, a cathode foil arranged opposite to the anode foil, and a separator arranged between the anode foil and the cathode foil,
at least one of the anode foil and the cathode foil includes a metal foil including at least one porous portion and a core portion that is continuous to the porous portion,
the metal foil has at least one main surface in which pores in the porous portion are open,
the porous portion includes a plurality of recessed portions that are open in the main surface and distributed in a dot pattern in an in-plane direction of the main surface,
the pores in the porous portion have an opening diameter smaller than 2 μm,
recessed portions that are adjacent to each other among the recessed portions have opening diameters D₁ μm and D₂ μm, respectively, and are spaced apart from each other by a distance L μm,
the opening diameter D₁ and the distance L satisfy 2≤D₁ and 2≤L/D₁≤50, and
the opening diameter D₂ and the distance L satisfy 2≤D₂ and 2≤L/D₂≤50.

11. The electrolytic capacitor according to claim 10,
wherein the metal foil has a length L_{W} mm in a direction perpendicular to a winding direction of the wound body, and
the number of recessed portions present per L_{W}² mm² of the main surface is 30 or more and 2660 or less.

12. The electrolytic capacitor according to claim 10,
wherein there are cracks between the recessed portions.

13. The electrolytic capacitor according to claim 12,
wherein the cracks extend in such a manner as to connect at least two recessed portions among the recessed portions in a direction perpendicular to the winding direction of the metal foil.

14. The electrolytic capacitor according to claim 12,
wherein the cracks are present at least in a region P of the wound body, and
when a thickness of the wound body in a radial direction from an innermost circumferential surface to an outermost circumferential surface is denoted by t, the region P is a region from the innermost circumferential surface of the wound body to an area at a distance of t/4 in the radial direction.

15. The electrolytic capacitor according to claim 14,
wherein more cracks are present in the region P than in a remaining region of the wound body excluding the region P.

16. The electrolytic capacitor according to claim 10,
wherein the at least one porous portion includes a first porous portion and a second porous portion arranged in such a manner as to sandwich the core portion,
the at least one main surface includes a first main surface in which pores in the first porous portion are open and a second main surface in which pores in the second porous portion are open, and
the plurality of recessed portions include a plurality of first recessed portions that are arranged in the first porous portion and open in the first main surface.

17. The electrolytic capacitor according to claim 16,
wherein the plurality of recessed portions include a plurality of second recessed portions that are arranged in the second porous portion and open in the second main surface.

18. The electrolytic capacitor according to claim 17,
wherein the first recessed portions and the second recessed portions are provided at positions where the first recessed portions and the second recessed portions are not opposite to each other via the core portion.

19. The electrolytic capacitor according to claim 16,
wherein, in the wound body, the metal foil is wound in such a manner that the first main surface faces an outer circumferential surface side of the wound body.

20. An electrolytic capacitor comprising:
a wound body; and
an electrolyte,
wherein the wound body is obtained by winding together an anode foil, a cathode foil arranged opposite to the anode foil, and a separator arranged between the anode foil and the cathode foil,
at least one of the anode foil and the cathode foil includes a metal foil including at least one porous portion and a core portion that is continuous to the porous portion,
the metal foil has at least one main surface in which pores in the porous portion are open,
the pores in the porous portion have an opening diameter smaller than 2 μm,
the porous portion includes a plurality of recessed portions that are open in the main surface and distributed in a dot pattern in an in-plane direction of the main surface,
the recessed portions have an opening diameter of 2 μm or more, and
there are cracks between the recessed portions.

21. The electrolytic capacitor according to claim 20,
wherein recessed portions that are adjacent to each other among the recessed portions have opening diameters D₁ μm and D₂ μm, respectively, and are spaced apart from each other by a distance L μm,
the opening diameter D₁ and the distance L satisfy 2≤D₁ and 2≤L/D₁≤50, and
the opening diameter D₂ and the distance L satisfy 2≤D₂ and 2≤L/D₂≤50.

22. The electrolytic capacitor according to claim 20,
wherein the metal foil has a length L_{W} mm in a direction perpendicular to a winding direction of the wound body, and
the number of recessed portions present per L_{W}² mm² of the main surface is 30 or more and 2660 or less.

23. The electrolytic capacitor according to claim 20,
wherein the cracks extend in such a manner as to connect at least two recessed portions among the recessed portions in a direction perpendicular to a winding direction of the metal foil.

24. The electrolytic capacitor according to claim 20,
wherein the cracks are present at least in a region P of the wound body, and
when a thickness of the wound body in a radial direction from an innermost circumferential surface to an outermost circumferential surface is denoted by t, the region P is a region from the innermost circumferential surface of the wound body to an area at a distance of t/4 in the radial direction.

25. The electrolytic capacitor according to claim 24,
wherein more cracks are present in the region P than in a remaining region of the wound body excluding the region P.

26. The electrolytic capacitor according to claim 20,
wherein the at least one porous portion includes a first porous portion and a second porous portion arranged in such a manner as to sandwich the core portion,
the at least one main surface includes a first main surface in which pores in the first porous portion are open and a second main surface in which pores in the second porous portion are open, and
the plurality of recessed portions include a plurality of first recessed portions that are arranged in the first porous portion and open in the first main surface.

27. The electrolytic capacitor according to claim 26,
wherein the plurality of recessed portions include a plurality of second recessed portions that are arranged in the second porous portion and open in the second main surface.

28. The electrolytic capacitor according to claim 27,
wherein the first recessed portions and the second recessed portions are provided at positions where the first recessed portions and the second recessed portions are not opposite to each other via the core portion.

29. The electrolytic capacitor according to claims 26,
wherein, in the wound body, the metal foil is wound in such a manner that the first main surface faces an outer circumferential surface side of the wound body.
